(19) United States
(12) Patent Application Publication
(10) Pub. No.: US 2009/0258988 A1
(43) Pub. Date: Oct. 15, 2009

(54) Composition Comprising Sulfurized Particles

(75) Inventors: Rabindra N. Datta, Schalkhaar (NL); Matinus G.M.W. Peters, Nijmegen (NL); Sebastianus C.J. Pierik, Lent (NL); Peter G. Akker, Doetichem (NL)

Correspondence Address: OLIFF & BERRIDGE, PLC, P.O. BOX 320850, ALEXANDRIA, VA, 22320-4850, US

(73) Assignee: TEIJIN ARAMID B.V., ARNHEM (NL)

(21) Appl. No.: 11/992,937

(22) PCT Filed: Oct. 6, 2006
(86) PCT No.: PCT/EP2006/009704

§ 371 Date: May 28, 2008

(30) Foreign Application Priority Data
Oct. 10, 2005 (EP) 05022046.6
Jun. 14, 2006 (EP) 06012200.9

(51) Int. Cl. C08L 81/04; B60C 1/00

(52) U.S. Cl. 524/502; 524/609

(57) ABSTRACT

The invention pertains to a composition comprising a particle and a matrix, the particle being at least partially coated with a composition comprising: a) a Bunte salt (A); b) a polysulfide (B) comprising the moiety —[S]ₙ— or —[S]₀—Zn—[S]ₚ, wherein each of o and p is 1-5, o+p=n, and n=2-6; and c) sulfur or a sulfur donor (C). Preferably, the matrix contains a wax. Most preferred polysulfide (B) has the formula: wherein each of o and p is 1-5, o+p=n, and n=2-6; and R is independently selected from hydrogen, halogen, nitro, hydroxy, C1-C12 alkyl, C1-C12 alkoxy, and C1-C12 aralkyl; and d) sulfur or a sulfur donor (C). The invention further relates to a vulcanization process comprising the use of said composition, the elastomer composition thus obtained, and a skim composition, tire, tire tread, undertread, or belt containing the same.

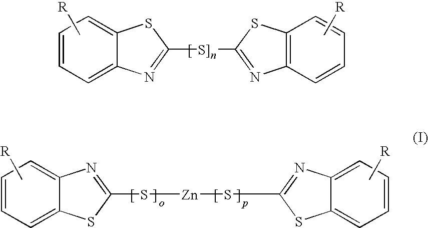

The invention pertains to a composition comprising a particle and a matrix. The invention further relates to a vulcanization process using said compositions, to an elastomer composition obtainable by said process, and to a skim product, a tire, and a tire tread, undertread or belt comprising said elastomer composition.

In the tire and belt industries, among others, better mechanical, heat build up and hysteresis properties are demanded. It has long been known that the mechanical properties of rubber can be improved by using large amounts of sulfur as a cross-linking agent to increase the crosslink density in vulcanized rubbers. However, the use of large amounts of sulfur suffers from the disadvantage of high heat generation that leads in the final product to a marked decrease in heat resistance and resistance to flex cracking, among other properties. Chopped fiber can improve the properties as mentioned, but processing of such compounds suffers because of high modulus fiber material incorporation to a viscous rubber matrix.

It is an object of the present invention to alleviate the disadvantages of prior art fibers.

To this end the invention pertains to a composition comprising a particle and a matrix, the particle being at least partially coated with a composition comprising a Bunte salt, a polysulfide, and sulfur or a sulfur donor. As matrix a wax can be used, which wax also can act as solvent for the Bunte salt, a polysulfide and sulfur making the process simpler avoiding the use of solvent/water dispersion and drying step. The composition can be a particle or a pellet made thereof.

Pellets as such are known in the art. For instance, in EP 0 889 072 the coating of aramid fiber pellets with a polymeric component, e.g. a wax, are disclosed. These pellets are however not coated with a Bunte salt.

In U.S. Pat. No. 6,068,922 pellets comprising aramid fibers and an extrudable polymer, e.g. polyethylene, polypropylene or polyamides are disclosed. The fibers may be coated by typical sizing agents (RF, epoxy, silicone), but a Bunte salt is not mentioned.

The present invention more specifically relates to a composition comprising a particle and a matrix, the particle being at least partially coated with a composition comprising:

a) a Bunte salt (A);
b) a polysulfide (B) comprising the moiety —[S]ₙ— or —[S]ₒ—Zn—[S]ₚ, wherein each of o and p is 1-5, o+p=n, and n=2-6; and
c) sulfur or a sulfur donor (C).

The polysulfide (B) may be any polysulfide comprising the moiety —[S]ₙ— or —[S]ₒ—Zn—[S]ₚ, wherein each of o and p is 1-5, o+p=n, and n=2-6. Examples of such polysulfides comprise:

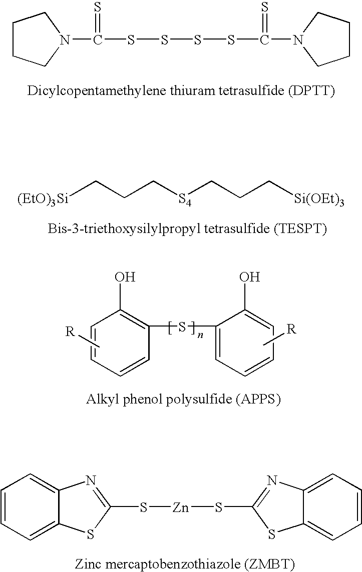

wherein R is independently selected from hydrogen, halogen, nitro, hydroxy, C1-C12 alkyl, C1-C12 alkoxy, and C1-C12 aralkyl.

A particularly suitable polysulfide has the formula:

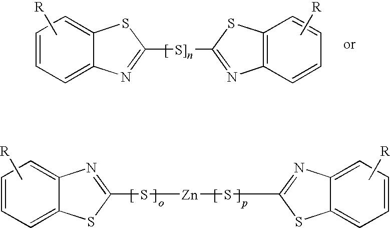

wherein each of o and p is 1-5, o+p=n, and n=2-6; and R has the herein above given meanings.

These compositions provide a solution to the above problems in the sulfur vulcanization of rubbers and provide rubber compositions that solve a longstanding problem of reducing hysteresis and heat generation.

The term “pellet” includes terms, apart from pellet, that are synonymous or closely related such as tablet, briquette, pastilles, granule and the like. Pellets can be made from any particle, including short cut fibers, chopped fiber, staple fiber, pulp, fibrils, fibrid, beads, and powder, by mixing these particles with a matrix of a wax and/or an extrudable polymer and the required sulfur chemicals.

Preferred particles are selected from aramid, polyester, polyamide, cellulose, glass, and carbon. Aramid fibers and powders have the preference, more specifically of poly(p-phenylene-terephthalamide) or co-poly(paraphenylene/3,4′-oxydiphenylene terephthalamide). Most preferred are staple fiber, chopped fiber, and powder. Powder and beads have the additional advantage that they do not need a spinning step and can directly be obtained from the polymer.

If the particle is a fiber, for many applications it is further of an additional advantage to pre-treat the fiber with a sizing.

Pellets can be prepared in any manner known in the art. For instance, pellets can be made from any particle, by mixing these particles with a wax and/or an extrudable polymer and optionally the required sulfur chemicals. This mixture can be extruded to pellets and used as such. Furthermore, the mixture and/or the extruded mixture can be compressed in the shape of a pellet, tablet, briquette, pastille, or the like. If not yet added sulfur chemicals can be applied to the pellet. Optionally, before compression the mixture is heated to provide a better dispersion of the sulfur chemicals and the particles in the wax and/or extrudable polymer. In WO 0058064 another method is described for preparing pellets from staple fiber and an extrudable polymer matrix. According to this method pellets are made by mixing staple fiber and polymer, heating the fibers to at least the melting or softening point of the wax and/or extrudable polymer. The mixture is then cooled and shaped to a strand, which strand is cut to small pieces (i.e. pellets). These pellets can be treated with sulfur chemicals and optionally a wax.

Continuous fiber can be treated with the sulfur chemicals prior to or after cutting the fiber to chopped fiber. The continuous fiber can be cut to staple fiber and used for the production of sulfurized pellets. If the particles are staple fiber these can be mixed with an extrudable polymer matrix, heated to at least the melting or softening point of the extrudable polymer, cooled, shaped to a strand and cut to pellets.

The matrix is a wax, an extrudable polymer, or a mixture thereof. In a preferred embodiment the invention relates to a waxed sulfurized particle or pellet having enhanced rubber properties in an elastomer, wherein 10 to 90 wt. % of the composition consists of matrix, preferably wax. Examples of suitable waxes are microcrystalline wax of higher alkyl chains, such as C22-C38 alkyl chains, paraffin wax or alkyl long chain fatty acid waxes, such as C16-C22 alkanecarboxylic acids. Examples of extrudable polymers are polyethylene, polypropylene, and polyamide. The extrudable polymers may be modified or unmodified polymers and copolymers. Mixtures of an extrudable polymer and a wax are particularly useful as matrix.

Preferably, the composition further comprises a coating composition wherein the weight ratio of compounds A:B:C is 4-80:0.1-25:0.05-15.

The preferred Bunte salt has the formula

(H)_{m′}—(R¹—S—SO₃⁻M⁺)ₘ.xH₂O wherein m is 1 or 2, m′ is 0 or 1, and m+m′=2; x is 0-3, M is selected from Na, K, Li, ½ Ca, ½ Mg, and ⅓ Al and R¹ is selected from C1-C12 alkylene, C1-C12 alkoxylene, and C7-C12 aralkylene.

The most preferred Bunte salt has m is 2, m′ is 0, and R¹ is C1-C12 alkylene.

The treatment of the particle is based on the above Bunte salt and/or polysulfide compound sulfur chemicals, disodium hexamethylene-1,6-bis(thiosulfate) dihydrate, 2-mercaptobenzothiazyl disulfide, and preferably aliphatic fatty acid waxes, which chemicals further contain sulfur and/or a sulfur donor.

The treatment of the particles can be carried out using a wax containing disodium hexamethylene-1,6-bis(thiosulfate) dihydrate, 2-mercaptobenzothiazyl disulfide, or in a mixture of sulfur-containing chemicals. Sulfur can additionally be used. 2-Mercaptobenzothiazyl disulfide (MBTS) can be replaced by other benzothiazole derivatives. A particularly useful sulfur chemical of the present invention is a mixture consisting of:

i. a Bunte salt, NaSO₃—S—(CH₂)₆—S—SO₃Na.2H₂0
ii. MBTS,

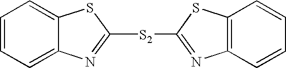

iii. sulfur or a sulfur donor

In another aspect the invention relates to a rubber composition which is the vulcanization reaction product of a rubber, sulfur and optionally sulfur donor, and said compositions. The composition improves processing, acts as a modulus enhancer, strength improver, as well lowers hysteresis. Also disclosed is a vulcanization process carried out in the presence of the compositions containing sulfur chemicals and the use of these compositions in the sulfur-vulcanization of rubbers.

In addition, the present invention relates to a vulcanization process carried out in the presence of the sulfurized composition and the use of this composition in the sulfur-vulcanization of rubbers. Further, the invention also encompasses rubber products which comprise at least some rubber which has been vulcanized, preferably vulcanized with sulfur, in the presence of said sulfurized compositions.

The present invention provides excellent processing behavior in addition to improved hysteresis behavior as well as improvements in several rubber properties without having a significant adverse effect on the remaining properties, when compared with similar sulfur-vulcanization systems without any sulfurized composition.

The present invention is applicable to all natural and synthetic rubbers. Examples of such rubbers include, but are not limited to, natural rubber, styrene-butadiene rubber, butadiene rubber, isoprene rubber, acrylonitrile-butadiene rubber, chloroprene rubber, isoprene-isobutylene rubber, brominated isoprene-isobutylene rubber, chlorinated isoprene-isobutylene rubber, ethylene-propylene-diene terpolymers, as well as combinations of two or more of these rubbers and combinations of one or more of these rubbers with other rubbers and/or thermoplastics.

Sulfur, optionally together with sulfur donors, provides the required level of sulfur during the vulcanization process. Examples of sulfur which may be used in the vulcanization process include various types of sulfur such as powdered sulfur, precipitated sulfur and insoluble sulfur. Examples of sulfur donors include, but are not limited to, tetramethylthiuram disulfide, tetraethylthiuram disulfide, tetrabutylthiuram disulfide, dipentamethylene thiuram hexasulfide, dipentamethylene thiuram tetrasulfide, dithiodimorpholine, and mixtures thereof.

Sulfur donors may be used instead or in addition to the sulfur. Herein the term “sulfur” further also includes the mixture of sulfur and sulfur donor(s). Further, references to the quantity of sulfur employed in the vulcanization process, when applied to sulfur, donors mean a quantity of sulfur donor which is required to provide the equivalent amount of sulfur that is specified.

More particularly, the present invention relates to a sulfur-vulcanized rubber composition which comprises the vulcanization reaction product of: (a) 100 parts by weight of at least one natural or synthetic rubber; (b) 0.1 to 25 parts by weight of an amount of sulfur, or sulfur and/or a sulfur donor, to provide the equivalent of 0.1 to 25 parts by weight of sulfur; and (c) 0.1 to 20 parts by weight of a (preferably) waxed sulfurized compositions, preferably aramid pellets.

If the particles are fibers, the sulfurized fibers of the present invention are based on natural and synthetic yarns. Examples of such yarns include, but not limited to, aramid, such as para-aramid, polyamide, polyester, cellulose, such as rayon, glass, and carbon as well as combinations of two or more of these yarns. The other sulfurized particles of the present invention can be made of the same compounds or combinations thereof.

Most preferably the particle is poly(para-phenylene-terephthalamide), which as fiber is commercially available under the trade name Twaron®, or co-poly(para-phenylene/3,4′-oxydiphenylene terephthalamide, which as fiber is commercially available under the trade name Technora®.

The amount of sulfur to be compounded with the rubber is, based on 100 parts of rubber, usually 0.1 to 25 parts by weight, and more preferably 0.2 to 8 parts by weight. The amount of sulfur donor to be compounded with the rubber is an amount to provide an equivalent amount of sulfur, i.e. an amount which gives the same amount of sulfur, as if sulfur itself were used. The amount of sulfurized composition to be compounded with the rubber is, based on 100 parts of rubber, 0.1 to 25 parts by weight, and more preferably 0.2 to 10.0 parts by weight, and most preferably 0.5 to 5 parts by weight. These ingredients may be employed as a pre-mix, or added simultaneously or separately, and they may be added together with other rubber compounding ingredients as well. In most circumstances it is also desirable to have a vulcanization accelerator in the rubber compound. Conventional, known vulcanization accelerators may be employed. The preferred vulcanization accelerators include mercaptobenzothiazole, 2,2′-mercaptobenzothiazole disulfide, sulfenamide accelerators including N-cyclohexyl-2-benzothiazole sulfenamide, N-tert-butyl-2-benzothiazole sulfenamide, N,N-dicyclohexyl-2-benzothiazole sulfenamide, and 2-(morpholinothio)benzothiazole; thiophosphoric acid derivative accelerators, thiurams, dithiocarbamates, diphenyl guanidine, diorthotolyl guanidine, dithiocarbamylsulfenamides, xanthates, triazine accelerators and mixtures thereof.

When the vulcanization accelerator is employed, quantities of from 0.1 to 8 parts by weight, based on 100 parts by weight of rubber composition, are used. More preferably, the vulcanization accelerator comprises 0.3 to 4.0 parts by weight, based on 100 parts by weight of rubber. Other conventional rubber additives may also be employed in their usual amounts. For example, reinforcing agent such as carbon black, silica, clay, whiting, and other mineral fillers, as well as mixtures of fillers, may be included in the rubber composition. Other additives such as process oils, tackifiers, waxes, antioxidants, antiozonants, pigments, resins, plasticizers, process aids, factice, compounding agents and activators such as stearic acid and zinc oxide may be included in conventional, known amounts. For a more complete listing of rubber additives which may be used in combination with the present invention see, W. Hofmann, Rubber Technology Handbook, Chapter 4, Rubber Chemicals and Additives, pp. 217-353, Hanser Publishers, Munich 1989.

Further, scorch retarders such as phthalic anhydride, pyromellitic anhydride, benzene hexacarboxylic trianhydride, 4-methylphthalic anhydride, trimellitic anhydride, 4-chlorophthalic anhydride, N-cyclohexyl-thiophthalimide, salicylic acid, benzoic acid, maleic anhydride and N-nitrosodiphenylamine may also be included in the rubber composition in conventional, known amounts. Finally, in specific applications it may also be desirable to include steel-cord adhesion promoters such as cobalt salts and dithiosulfates in conventional, known quantities.

The process is carried out at a temperature of 110-220° C. over a period of up to 24 hours. More preferably, the process is carried out at a temperature of 120-190° C. over a period of up to 8 hours in the presence of 0.1 to 20 parts by weight of waxed sulfurized compositions. Even more preferable is the use of 0.2-5 parts by weight of waxed sulfurized compositions. All of the additives mentioned above with respect to the rubber composition may also be present during the vulcanization process of the invention.

In a more preferred embodiment of the vulcanization process, the vulcanization is carried out at a temperature of 120-190° C. over a period of up to 8 hours and in the presence of 0.1 to 8 parts by weight, based on 100 parts by weight of rubber, of at least one vulcanization accelerator.

The present invention also includes articles of manufacture, such as skim products, tires, tire treads, tire undertreads, or belts, which comprise sulfur-vulcanized rubber which is vulcanized in the presence of the sulfurized composition of the present invention.

The invention is further illustrated by the following examples which are not to be construed as limiting the invention in any way.

### EXPERIMENTAL METHODS

### Compounding, Vulcanization and Characterization of Compounds

In the following examples, rubber compounding, vulcanization and testing was carried out according to standard methods except as otherwise stated: Base compounds were mixed in a Farrel Bridge™ BR 1.6 liter Banbury type internal mixer (preheating at 50° C., rotor speed 77 rpm, mixing time 6 min with full cooling).

Vulcanization ingredients were added to the compounds on a Schwabenthan Polymix™ 150 L two-roll mill (friction 1:1.22, temperature 70° C., 3 min).

Cure characteristics were determined using a Monsanto™ rheometer MDR 2000E (arc 0.5°) according to ISO 6502/1999. Delta S is defined as extent of crosslinking is derived from subtraction of lowest torque (ML) from highest torque (MH).

Sheets and test specimens were vulcanized by compression molding in a Fontyne™ TP-400 press.

Tensile measurements were carried out using a Zwick™ 1445 tensile tester (ISO-2 dumbbells, tensile properties according to ASTM D 412-87, tear strength according to ASTM D 624-86).

Abrasion was determined using a Zwick abrasion tester as volume loss per 40 m path traveled (DIN 53516).

Heat build-up and compression set after dynamic loading were determined using a Goodrich™ Flexometer (load 1 MPa, stroke 0.445 cm, frequency 30 Hz, start temperature 100° C., running time 120 min or till blow out; ASTM D 623-78). Dynamic mechanical analyses, for example loss modulus and tangent delta were carried out using an Eplexor™ Dynamic Mechanical Analyzer (pre-strain 10%, frequency 15 Hz, ASTM D 2231).

### Example 1

Pellets (25 g) consisting of polyethylene matrix and Twaron® p-aramid staple fiber were added to a mixture of the required sulfur chemicals in molten stearic acid at a temperature of 60 to 80° C. The stearic acid was rubber grade BM 100 supplied by Behn Meyer. The sulfur chemicals and their ratios to stearic acid are specified in Tables 1, 7, and 12. Next the mixture of pellets and sulfur chemicals containing molten stearic acid was stirred until uptake of the sulfur chemicals and molten stearic acid into the pellets had occurred. Then the stearic acid-containing pellets were transferred into a dry-ice containing polyethylene bag and kept in continuous motion while cooling down to a temperature below the stearic acid melting point. Finally, the contents of the bag were emptied on a sieve to remove remaining dry-ice and some stearic acid flakes.

### Example 2

2-Mercaptobenzothiazyl disulfide (MBTS) (0.617 g) and sulfur (0.305 g) were dissolved in 75 g of toluene at 60° C. 1.377 g of sorbitan trioleate (Span™ 85) and 0.468 g polyoxyethylene sorbitan monolaurate (Tween™ 20) were added for stabilization. 12.019 g of HTS (disodium hexamethylene 1,6-bis(thiosulfate)-dihydrate) were dissolved in 60 mL of water together with 0.442 g of Intrasol AFW, which is a mixture of an anionic copolymer and a C-16 hydrocarbon supplied by Bozzetto Gmbh. Under vigorous stirring the aqueous solution was added to the toluene solution. An ultraturrax was applied to the mixture resulting in a stable dispersion. Then, 25 g of pellets consisting of polyethylene matrix and Twaron® p-aramid staple fiber were dipped in about 150 mL of the dispersion for five minutes at room temperature, filtered off, and dried in air for approximately 18 hours and then under vacuum for about 6 hours.

### Example 3

A premix of stearic acid, HTS, MBTS and sulfur was prepared in the weight ratio 100:7.2:0.36:0.18. In a glass vessel, aramid particles (powder, chopped fiber or pulp) were intensively mixed with the premix as indicated above in a weight ratio of 1:2. Total mass was about 25 g. During mixing, the mixture was heated with a heat-gun until softening of the premix occurred. Mixing was continued while the mixture was allowed to cool down. Next approximately 1.5 g of the solidified mixture were transferred into a cylindrical mold at room temperature. A pressure of 20 bar was applied to shape the mixture into a pellet. In this way about 15 pellets were prepared for each sample (Samples P1 to P6).

### Example 4

The pellet compositions containing Twaron® p-aramid staple fibers were prepared according to Example 1 (T2 and T4) and Example 2 (T3) and are the following:

TABLE 1

| | Composition | | |
|---|---|---|---|
| Matrix:sulfur chemicals | (% by weight) | remark | entry |
| PE | 20 | comparison | T1 |
| PE:SA | 8.6:57 | comparison | T2 |
| PE:HTS:MBTS:S | 17.6:8.9:0.45:0.22 | invention | T3 |
| PE:SA:HTS:MBTS:S | 7.5:58:4:0.2:0.1 | invention | T4 |

SA is stearic acid; S is sulfur; PE is polyethylene; MBTS is 2-mercaptobenzo-thiazyl disulfide

The accelerator employed was N-cyclohexyl-2-benzothiazole sulfenamide (CBS). Details of the formulations are listed in Table 2.

TABLE 2
Rubber formulations incorporating aramid fiber pellets.

| | Experiment | | | | | |
|---|---|---|---|---|---|---|
| Ingredients | A | B | C | D | 1 | 2 |
| NR SMR 10 | 80 | 80 | 80 | 80 | 80 | 80 |
| BR Buna CB 24 | 20 | 20 | 20 | 20 | 20 | 20 |
| Black N-339 | 57 | 55 | 55 | 55 | 55 | 55 |
| Zinc oxide | 5 | 5 | 5 | 5 | 5 | 5 |
| Stearic acid | 2 | 2 | 2 | 1.5 | 2 | 1.5 |
| Aromatic oil | 8 | 8 | 8 | 8 | 8 | 8 |
| Antidegradant | 2 | 2 | 2 | 2 | 2 | 2 |
| 6PPD | | | | | | |
| Antioxidant TMQ | 1 | 1 | 1 | 1 | 1 | 1 |
| Accelerator CBS | 1.5 | 1.5 | 1.5 | 1.5 | 1.5 | 1.5 |
| Sulfur | 1.5 | 1.5 | 1.5 | 1.5 | 1.5 | 1.5 |
| T1 | 0 | 0 | 1 | 0 | 0 | 0 |
| T2 | 0 | 0 | 0 | 1 | 0 | 0 |
| T3 | 0 | 0 | 0 | 0 | 1 | 0 |
| T4 | 0 | 0 | 0 | 0 | 0 | 1 |

NR is natural rubber;
BR is polybutadiene;
6PPD is N-1,3-dimethylbutyl-N′-phenyl-p-phenylenediamine;
TMQ is polymerized 2,2,4-trimethyl-1,2-dihydoquinoline antioxidant;
CBS is N-cyclohexyl benzothiazyl sulfenamide.

The vulcanized rubbers listed in Table 2 were tested according to ASTM/ISO norms. A and B are control experiments, C-D are comparison experiments, and 1 and 2 are experiments according to the invention. The results are given in Tables 3-6.

TABLE 3
Effect of the mixes at 100° C. on processing characteristics.

Experiments

| Mooney viscosity | A | B | C | D | 1 | 2 |
|---|---|---|---|---|---|---|
| ML(1 + 4), MU | 55 | 53 | 57 | 56 | 56 | 54 |

The data of Table 3 show that the pellets according to the invention (wherein the sulfur ingredients are present, mix 1 and 2) show the low viscosity as evidenced from the ML (1+4) values.

TABLE 4
Effect of the mixes at 150° C. on delta torque.

| | Experiments | | | | | |
|---|---|---|---|---|---|---|
| | A | B | C | D | 1 | 2 |
| Delta S, Nm | 1.79 | 1.75 | 1.79 | 1.77 | 1.82 | 1.75 |

The data in Table 4 show that the pellets according to the invention (mix 1 and 2) do not influence the extent of crosslinking as demonstrated by delta S values.

TABLE 5
Evaluation of sulfurized pellets for improvement in mechanical
properties.

| | Experiments | | | | | |
|---|---|---|---|---|---|---|
| | A | B | C | D | 1 | 2 |
| Modulus, 300%, | 14.8 | 13.1 | 13.7 | 14.9 | 15.1 | 16 |
| MPa | | | | | | |
| Tear strength, kN/m | 120 | 135 | 140 | 120 | 150 | 150 |
| Abrasion loss, mm³ | 125 | 120 | 120 | 110 | 90 | 85 |

It is clear from the data depicted in Table 5 that the sulfurized pellet (mix 1) and the waxed sulfurized pellet (mix 2) of the invention have better modulus, tear strength and abrasion resistance.

TABLE 6
Evaluation of improvement in dynamic mechanical properties

| | Experiments | | | | | |
|---|---|---|---|---|---|---|
| | A | B | C | D | 1 | 2 |
| Temperature | 37 | 32 | 30 | 30 | 25 | 23 |
| rise, ° C. | | | | | | |
| Blow out time, | 18 | 25 | 26 | 29 | 44 | 48 |
| min | | | | | | |
| Loss modulus, | 1.33 | 1.2 | 1.18 | 1.15 | 1.01 | 0.97 |
| MPa | | | | | | |
| Tangent delta | 0.167 | 0.158 | 0.155 | 0.15 | 0.133 | 0.134 |

It is noted that the waxed sulfurized pellet (mix 2) shows similar properties as the sulfurized pellet (mix 1) with additional advantage in processing plus lower dosage with respect to the total fiber content.

### Example 5

Various polysulfides (DPTT, TESPT, and APPS) were evaluated. The fiber pellets were all based on Twaron® p-aramid staple fiber and were prepared as in Example 1. The compositions of Table 7 were obtained.

TABLE 7
Fiber pellet compositions.

| | Composition | | |
|---|---|---|---|
| Matrix:sulfur chemicals | (% by weight) | remark | Entry |
| PE:SA:APPS:S | 7.8:56.7:2.8:1.4 | comparison | K1 |
| PE:SA:DPTT:S | 7.8:56.6:2.7:1.4 | comparison | K2 |
| PE:SA:TESPT:S | 8.1:55.7:2.7:1.3 | comparison | K3 |
| PE:SA:S | 8.0:57.8:2.1 | comparison | K4 |
| PE:SA:HTS | 8.0:56.0:4.0 | comparison | K5 |
| PE:SA:HTS:APPS:S | 8.0:55.8:4.0:0.2:0.1 | invention | K6 |
| PE:SA:HTS:DPTT:S | 8.1:55.3:4.0:0.2:0.1 | invention | K7 |
| PE:SA:HTS:TESPT:S | 8.0:55.7:4.1:0.3:0.1 | invention | K8 |

DPTT is dicylcopentamethylene thiuram tetrasulfide; TESPT is bis-3-triethoxy-silylpropyl tetrasulfide; APPS is alkyl phenol polysulfide (APPS).

The rubber formulations using the material as described in Table 7 are shown in Table 8.

TABLE 8
Rubber formulations.

| | Experiment | | | | | | | | | |
|---|---|---|---|---|---|---|---|---|---|---|
| Ingredients | E | F | P | Q | R | S | T | 3 | 4 | 5 |
| NR, SMR 10 | 80 | 80 | 80 | 80 | 80 | 80 | 80 | 80 | 80 | 80 |
| BR, Buna CB24 | 20 | 20 | 20 | 20 | 20 | 20 | 20 | 20 | 20 | 20 |
| Black, N-339 | 57 | 55 | 55 | 55 | 55 | 55 | 55 | 55 | 55 | 55 |
| Zinc oxide | 5 | 5 | 5 | 5 | 5 | 5 | 5 | 5 | 5 | 5 |
| Stearic acid | 2 | 2 | 0 | 0 | 0 | 0 | 0 | 0 | 0 | 0 |
| Aromatic oil | 8 | 8 | 8 | 8 | 8 | 8 | 8 | 8 | 8 | 8 |
| Antiozonant | 2 | 2 | 2 | 2 | 2 | 2 | 2 | 2 | 2 | 2 |
| 6PPD | | | | | | | | | | |
| Antioxidant TMQ | 1 | 1 | 1 | 1 | 1 | 1 | 1 | 1 | 1 | 1 |
| Accelerator CBS | 1.5 | 1.5 | 1.5 | 1.5 | 1.5 | 1.5 | 1.5 | 1.5 | 1.5 | 1.5 |
| Sulfur | 1.5 | 1.5 | 1.5 | 1.5 | 1.5 | 1.5 | 1.5 | 1.5 | 1.5 | 1.5 |
| K1 | 0 | 0 | 3.0 | 0 | 0 | 0 | 0 | 0 | 0 | 0 |
| K2 | 0 | 0 | 0 | 3.0 | 0 | 0 | 0 | 0 | 0 | 0 |
| K3 | 0 | 0 | 0 | 0 | 3.0 | 0 | 0 | 0 | 0 | 0 |
| K4 | 0 | 0 | 0 | 0 | 0 | 3.0 | 0 | 0 | 0 | 0 |
| K5 | 0 | 0 | 0 | 0 | 0 | 0 | 3.0 | 0 | 0 | 0 |
| K6 | 0 | 0 | 0 | 0 | 0 | 0 | 0 | 3.0 | 0 | 0 |
| K7 | 0 | 0 | 0 | 0 | 0 | 0 | 0 | 0 | 3.0 | 0 |
| K8 | 0 | 0 | 0 | 0 | 0 | 0 | 0 | 0 | 0 | 3.0 |

The vulcanized rubbers listed in Table 8 were tested according to relevant ASTM/ISO norms. E and F are control experiments, P-T are comparison experiments, and 3-5 are experiments according to the invention. The results are given in Tables 9-11.

TABLE 9
Effect of the mixes at 150° C. on cure data.

| | Experiment | | | | | | | | | |
|---|---|---|---|---|---|---|---|---|---|---|
| | E | F | P | Q | R | S | T | 3 | 4 | 5 |
| Delta S, Nm | 1.74 | 1.72 | 1.72 | 1.75 | 1.78 | 1.75 | 1.76 | 2.06 | 1.98 | 2.00 |

The data in Table 9 show that the fiber pellets according to the invention (mixes 3, 4, and 5) show the highest reinforcement as demonstrated by delta torque values.

TABLE 10
Evaluation of sulfurized fiber pellets for the improvement in mechanical
properties.

| | Experiment | | | | | | | | | |
|---|---|---|---|---|---|---|---|---|---|---|
| | E | F | P | Q | R | S | T | 3 | 4 | 5 |
| Modulus, | 15.4 | 14.0 | 14.4 | 14.7 | 14.7 | 14.4 | 14.1 | 15.5 | 15.1 | 15.5 |
| 300%, MPa | | | | | | | | | | |
| tear | 128 | 130 | 130 | 135 | 120 | 125 | 120 | 165 | 170 | 170 |
| strength kN/m | | | | | | | | | | |
| Abrasion | 120 | 140 | 120 | 115 | 125 | 120 | 115 | 90 | 90 | 90 |
| resistance | | | | | | | | | | |
| mm³ | | | | | | | | | | |

The data of Table 10 show that the fiber pellets of the invention have better modulus, tear strength, and abrasion resistance.

The advantages in the hysteresis (tangent delta) are shown in Table 11.

TABLE 11
Evaluation of improvement in dynamic mechanical properties.

| | Experiment | | | | | | | | | |
|---|---|---|---|---|---|---|---|---|---|---|
| | E | F | P | Q | R | S | T | 3 | 4 | 5 |
| Storage | 7.46 | 7.44 | 7.33 | 7.16 | 7.71 | 7.39 | 7.55 | 7.45 | 7.41 | 7.99 |
| modulus, MPa | | | | | | | | | | |
| loss modulus | 1.12 | 1.08 | 0.98 | 0.95 | 1.06 | 1.09 | 1.11 | 0.93 | 0.91 | 0.96 |
| MPa | | | | | | | | | | |
| Tangent delta | 0.150 | 0.145 | 0.134 | 0.132 | 0.141 | 0.142 | 0.147 | 0.125 | 0.123 | 0.121 |

### Example 6

The use of Zinc mercaptobenzothiazole (ZMBT) was evaluated in this experiment. The fiber pellets were all based on Twaron® p-aramid staple fiber and were prepared as in Example 1. The compositions of Table 12 were obtained.

TABLE 12
Fiber pellet compositions.

| Matrix: sulfur | Composition | | |
|---|---|---|---|
| chemicals | (% by weight) | remark | entry |
| PE:SA:HTS:MBTS:S | 8.2:54.8:3.9:0.2:0.1 | invention | T5 |
| PE:SA:HTS:ZMBT:IS | 8.7:52.6:3.8:0.2:0.1 | invention | T6 |

IS = insoluble sulfur (Crystex HS OT 20)

The accelerator employed was N-cyclohexyl-2-benzothiazole sulfenamide (CBS). Details of the formulations are listed in Table 13.

TABLE 13
Rubber formulations incorporating aramid fiber pellets.

| | Experiment | | |
|---|---|---|---|
| Ingredients | U | 6 | 7 |
| NR SMR 10 | 80 | 80 | 80 |
| BR Buna CB 24 | 20 | 20 | 20 |
| Black N-339 | 55 | 55 | 55 |
| Zinc oxide | 5 | 5 | 5 |
| Stearic acid | 2 | 0 | 0 |
| Aromatic oil | 8 | 8 | 8 |
| Antidegradant 6PPD | 2 | 2 | 2 |
| Antioxidant TMQ | 1 | 1 | 1 |
| Accelerator CBS | 1.5 | 1.5 | 1.5 |
| Sulfur | 1.5 | 1.5 | 1.5 |
| T5 | 0 | 3 | 0 |
| T6 | 0 | 0 | 3 |

The vulcanized rubbers listed in Table 13 were tested according to ASTM/ISO norms. U is a control experiment without aramid fiber pellets, and 6 and 7 are experiments according to the invention. The results are given in Tables 14-16.

TABLE 14
Effect of the mixes at 150° C. on delta torque.

| Experiments | U | 6 | 7 |
|---|---|---|---|
| Delta S, Nm | 1.72 | 1.73 | 1.78 |

The data in Table 14 show that the pellets according to the invention (mix 6 and 7) do not influence the extent of crosslinking as demonstrated by delta S values.

TABLE 15
Evaluation of sulfurized fiber pellets for
improvement in mechanical properties.

| Experiments | U | 6 | 7 |
|---|---|---|---|
| Modulus, 300%, MPa | 14.0 | 14.9 | 14.9 |
| Abrasion loss, mm³ | 80 | 76 | 78 |

It is clear from the data depicted in Table 15 that the pellets according to the invention have better modulus, and abrasion resistance.

TABLE 16
Evaluation of improvement in dynamic mechanical properties

| Experiments | U | 6 | 7 |
|---|---|---|---|
| Temperature rise, ° C. | 28 | 26 | 23 |
| Blow out time, min | 36 | 40 | 51 |
| Tangent delta | 0.148 | 0.138 | 0.131 |

It is clear from the data depicted in Table 16 that the pellets according to the invention have better dynamic mechanical properties.

### Example 7

Various aramid pellets were based on Twaron® p-aramid powder, pulp or chopped fiber. The composition of the pellets is aramid:SA:HTS:MBTS:S=33.3:61.9:4.5:0.2:0.1. Pellets were prepared as in Example 3.

TABLE 17
Aramid particle pellet compositions according to the invention.

| Particle type | Entry |
|---|---|
| Powder (Twaron ® 5011) | P1 |
| Pulp (SPP)* | P2 |
| Pulp (Twaron ®1093) | P3 |
| Pulp (Twaron ®3091) | P4 |
| Chopped fiber (6 mm) | P5 |

*according to Example 1 of WO 2005/059211

The rubber formulations using the material as described in Table 17 are shown in Table 18.

TABLE 18
Rubber formulations.

| | Experiment | | | | | |
|---|---|---|---|---|---|---|
| Ingredients | V | 8 | 9 | 10 | 11 | 12 |
| NR, SMR 10 | 80 | 80 | 80 | 80 | 80 | 80 |
| BR, Buna CB24 | 20 | 20 | 20 | 20 | 20 | 20 |
| Black, N-339 | 55 | 55 | 55 | 55 | 55 | 55 |
| Zinc oxide | 5 | 5 | 5 | 5 | 5 | 5 |
| Stearic acid | 2 | 0 | 0 | 0 | 0 | 0 |
| Aromatic oil | 8 | 8 | 8 | 8 | 8 | 8 |
| Antiozonant | 2 | 2 | 2 | 2 | 2 | 2 |
| 6PPD | | | | | | |
| Antioxidant TMQ | 1 | 1 | 1 | 1 | 1 | 1 |
| Accelerator CBS | 1.5 | 1.5 | 1.5 | 1.5 | 1.5 | 1.5 |
| Sulfur | 1.5 | 1.5 | 1.5 | 1.5 | 1.5 | 1.5 |
| P1 | 0 | 3.0 | 0 | 0 | 0 | 0 |
| P2 | 0 | 0 | 3.0 | 0 | 0 | 0 |
| P3 | 0 | 0 | 0 | 3.0 | 0 | 0 |
| P4 | 0 | 0 | 0 | 0 | 3.0 | 0 |
| P5 | 0 | 0 | 0 | 0 | 0 | 3.0 |

The vulcanized rubbers listed in Table 18 were tested according to relevant ASTM/ISO norms. V is a control experiments without aramid particle pellets, and 8-12 are experiments according to the invention. The results are given in Tables 19 and 20.

TABLE 19
Effect of the mixes at 150° C. on cure data.

| | Experiment | | | | | |
|---|---|---|---|---|---|---|
| | V | 8 | 9 | 10 | 11 | 12 |
| Delta S, Nm | 1.73 | 1.76 | 1.76 | 1.78 | 1.76 | 1.88 |

The data in Table 9 show that the pellets according to the invention (mixes 8 to 11) do not influence the extent of crosslinking as demonstrated by delta S values. Only for mix 12 a small effect is observed.

TABLE 20
Evaluation of improvement in dynamic mechanical properties

| | Experiment | | | | | |
|---|---|---|---|---|---|---|
| | V | 8 | 9 | 10 | 11 | 12 |
| Storage | 7.02 | 7.21 | 7.32 | 6.85 | 7.14 | 7.26 |
| modulus, MPa | | | | | | |
| loss modulus | 1.00 | 0.98 | 0.97 | 0.82 | 0.94 | 0.99 |
| MPa | | | | | | |
| Tangent delta | 0.151 | 0.134 | 0.132 | 0.120 | 0.132 | 0.134 |

It is clear from the data depicted in Table 20 that the pellets according to the invention have better dynamic mechanical properties.

1. A composition comprising a particle and a matrix, the particle being at least partially coated with a composition comprising:
a) a Bunte salt (A);
b) a polysulfide (B) comprising the moiety —[S]n- or —[S]o-Zn—[S]p, wherein each of o and p is 1-5, o+p=n, and n=2-6;
c) sulfur or a sulfur donor (C).

2. The composition of claim 1 wherein 10 to 90 wt. % of the total weight of the composition consists of matrix.

3. The composition of claim 2 wherein the matrix is an aliphatic fatty acid wax, or a synthetic microcrystalline wax having C22-C38 alkyl chains, optionally with an extrudable polymer.

4. The composition of claim 3 wherein the wax is a saturated alkanecarboxylic acid having 16-22 carbon atoms.

5. The composition of claim 1 wherein the coating composition contains polysulfide having the formula: 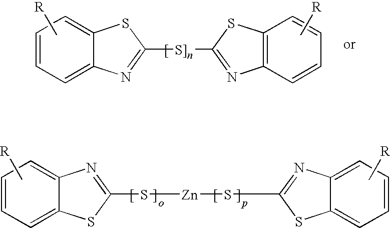
wherein each of o and p is 1-5, o+p=n, and n=2-6; and
R is independently selected from hydrogen, halogen, nitro, hydroxy, C1-C12 alkyl, C1-C12 alkoxy, and C1-C12 aralkyl.

6. The composition of claim 1 wherein the weight ratio of compounds A:B:C in the coating composition is 4-80:0.1-25:0.05-15.

7. The composition of claim 1 wherein the coating composition contains a Bunte salt having the formula
(H)m′-(R1-S—SO3-M+)m.xH2O wherein m is 1 or 2, m′ is 0 or 1, and m+m′=2; x is 0-3, M is selected from Na, K, Li, ½ Ca, ½ Mg, and ⅓ Al and R1 is selected from C1-C12 alkylene, C1-C12 alkoxylene, and C7-C12 aralkylene.

8. The composition of claim 7 wherein M is Na, x is 0-2, R1 is C1-C12 alkylene, m is 2 and m′ is 0.

9. The composition of claim 1 wherein the particle is selected from aramid, polyester, polyamide, cellulose, glass, and carbon.

10. The composition of claim 1 wherein the particle is a poly(p-phenylene-terephthalamide) or a co-poly-(paraphenylene/3,4′-oxydiphenylene terephthalamide) particle.

11. The composition of claim 1 wherein the particle is selected from chopped fiber, staple fiber, pulp, fibrils, fibrid, beads, and powder.

12. The composition of claim 1 wherein the particle is chopped fiber, staple fiber, pulp, or fibril pre-treated with a sizing.

13. The composition of claim 1 wherein the composition is a pellet.

14. A vulcanization process for making an elastomer composition comprising the step of vulcanizing:
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the composition of claim 1.

15. An elastomer composition obtainable by the method according to claim 14.

16. A skim product comprising the elastomer composition of claim 15 and a skim additive.

17. A tire comprising at least one of:
an elastomer composition including
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the composition of claim 1; and
a skim product including the elastomer composition and a skim additive.

18. A tire tread, undertread, or belt comprising at least one of:
an elastomer composition including
(a) 100 parts by weight of at least one natural or synthetic rubber;
(b) 0.1 to 25 parts by weight of an amount of sulfur and/or a sulfur donor, to provide the equivalent of 0.1 to 25 parts by weight of sulfur; and
(c) 0.1 to 20 parts by weight of the composition of claim 1; and
a skim product including the elastomer composition and a skim additive.
